(19) United States
(12) Patent Application Publication
(10) Pub. No.: US 2012/0073087 A1
(43) Pub. Date: Mar. 29, 2012

(54) Low friction cord lock

(76) Inventor: Robert A. Briganti, Los Altos, CA (US)

(21) Appl. No.: 12/924,443

(22) Filed: Sep. 27, 2010

(51) Int. Cl. F16G 11/04

(52) U.S. Cl. 24/122.6

(57) ABSTRACT

A cord lock with an internal structure designed to guide a pair of cord parts through the device smoothly to minimize friction thereby increasing final tension in the cord parts. And further designed to guide the cord exit on the operators side to facilitate a tightening method where the cord parts can be held one in each hand and pulled apart giving the operator more leverage and multiplying the tension force in the cord parts (13).

### SUMMARY

This device is used to selectively lock a pair of cords using a wedge between the two cords arranged within housing. The housing is specifically designed to minimize the friction of the cords by accepting them from substantially opposite directions and smoothly direct them out again in substantially opposite directions.

### BACKGROUND

1. Prior Art

There are a number of prior art designs similar to my cord lock. None, however, are fashioned in a way that minimizes the friction due to abrupt curves in the cord due to their design. The inner walls, which guide the cord in the prior inventions that cause these abrupt curves, are designed without regard for this effect. Furthermore, the accepted method of tightening is to hold the device with one hand and pull both cords through the device with the other hand. Evidence of this is shown in the illustrations in many of the prior art where the loose end of the cord is shown extending in a direction generally parallel to each other and parallel the axis of the device. The intended operation of this device involves tightening the cord by holding one cord in each hand and pulling outward on each separately. This provides a much greater mechanical advantage. Each of the prior art do not anticipate this method of tightening the cords. If this were anticipated by the prior art it would have been mentioned and illustrated. Another detail not anticipated by the prior art is that the wedge shaped locking member passes through the narrowest point of the cavity in the outer body of each device. Furthermore, the wedge effect of the previous devices is dependant in full or part on the shape of the inner cavity. The shape of the cavity in this device is shaped primarily to minimize deviation from a smooth path into and out of the device.

Boden 4,156,574, May 29, 1979, shows a locking device where, in FIG. 2 and FIG. 3, The inner surfaces that the cord is forced against while locked, is concave. This displaces the inevitable turn in the cord to a point immediately near each exit of the cavity of the device. Specifically, at both points 17, in FIG. 2, very tight turns cause the cord to curve in a very abrupt manor and then proceed outward in opposite directions. The cord will tend to resist this deflection, creating high friction, which works against the manual force from the operator. Furthermore, at the opening opposite each point 17 at 16 in FIG. 2 and FIG. 3, where the cord exits on the other end of the cavity, the shape is almost square. In the case where the operator holds one cord in each hand separately and pulls them apart, the square shape causes a friction effect that is additional to the friction force created at points 17. Each of these friction effects, together and separately result in less tension in the cord in its' final locked position and less effectiveness of the device.

Bengtsson, 3,564,670, Feb. 23, 1971, teaches a cord lock device with the same disadvantage created by the same type of concave shaped wall at 29 in FIG. 14. This displaces the inevitable turn in the cord creating conditions for an abrupt-friction-causing turn at 12 in FIG. 9 and FIG. 10 as well as 30 in FIG. 14.

### OBJECT AND ADVANTAGES

The object of my cord lock is to provide a cord lock that is easier to tighten and provide a greater tension in cords where this arrangement is needed. A further object is to deliberately facilitate a method of tightening the cord where the operator holds one cord in each hand and pulls them apart. The advantage to my cord lock is that the cord, passing through the cavity in the housing, is directed gradually from it's entry direction, through the cavity and then back out again without encountering abrupt deviations, bumps or dips as in the previous inventions. The smooth gradual redirection of the cord reduces the friction created as the cord is drawn through. The advantage of holding each cord in each hand is it provides a greater mechanical advantage practically quadrupling the force generated rather than holding the two cords in one hand. This doubles the manual force imparted to the cord providing a much greater final tension than can be generated in previous inventions. Furthermore, the wedge means can be drawn into the cavity a much greater distance with no limit established by the outer body. This allows and unlimited wedge force as needed.

### DRAWING FIGURES

FIG. 1 illustrates the cord lock fully assembled from the side. FIG. 2 shows the cord lock as it would appear as viewed in FIG. 1 from above. FIG. 3 is a cross sectional view of the cord lock at view line 3 of FIG. 2 in the unlocked position. FIG. 4 is the same as FIG. 3 with the cord lock in cross section in the unlocked position. FIG. 5 shows the cross section of the housing 11 only. FIG. 6 is the same as FIG. 2 showing housing 11 only. FIG. 7 shows the face view of wedge 12 alone. FIG. 8 shows the edge view of wedge 12 alone.

### DESCRIPTION

The embodiment illustrated in all the figures are fabricated in the same manner as anyone skilled in the art will have made other cord locks and can employ standard injection molding to fabricate any of the parts from polymers or use of other die forming or molding methods.

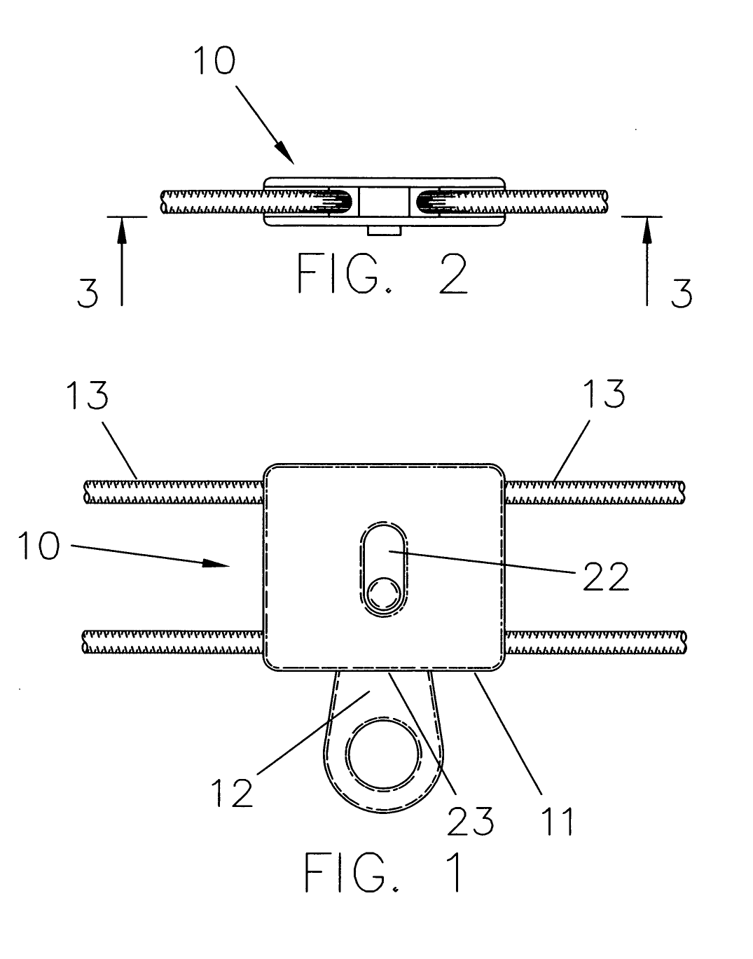

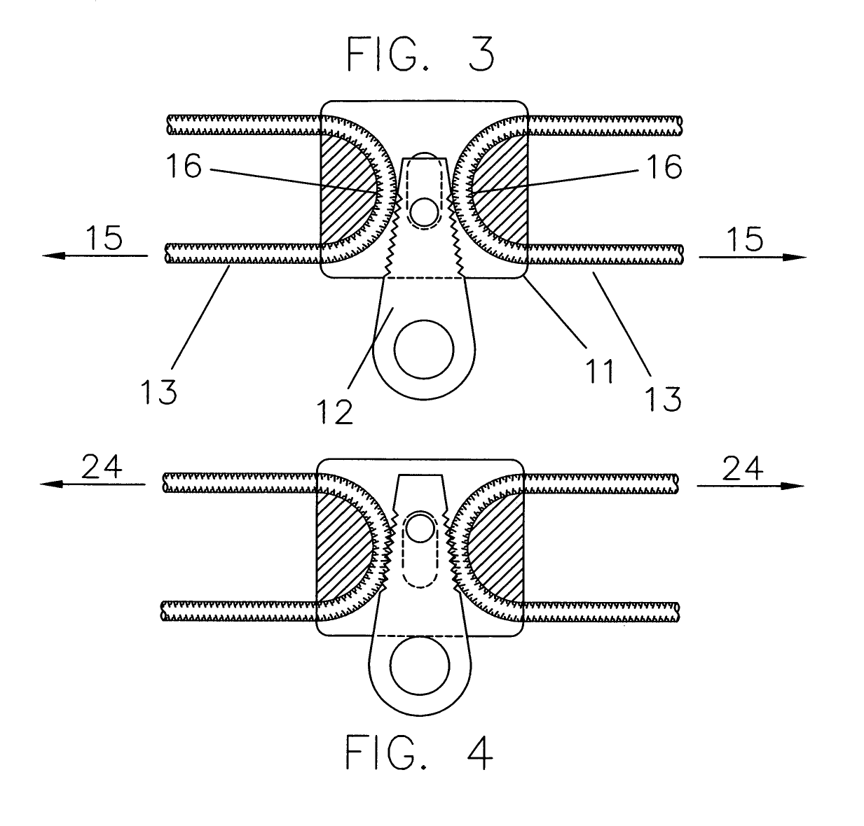

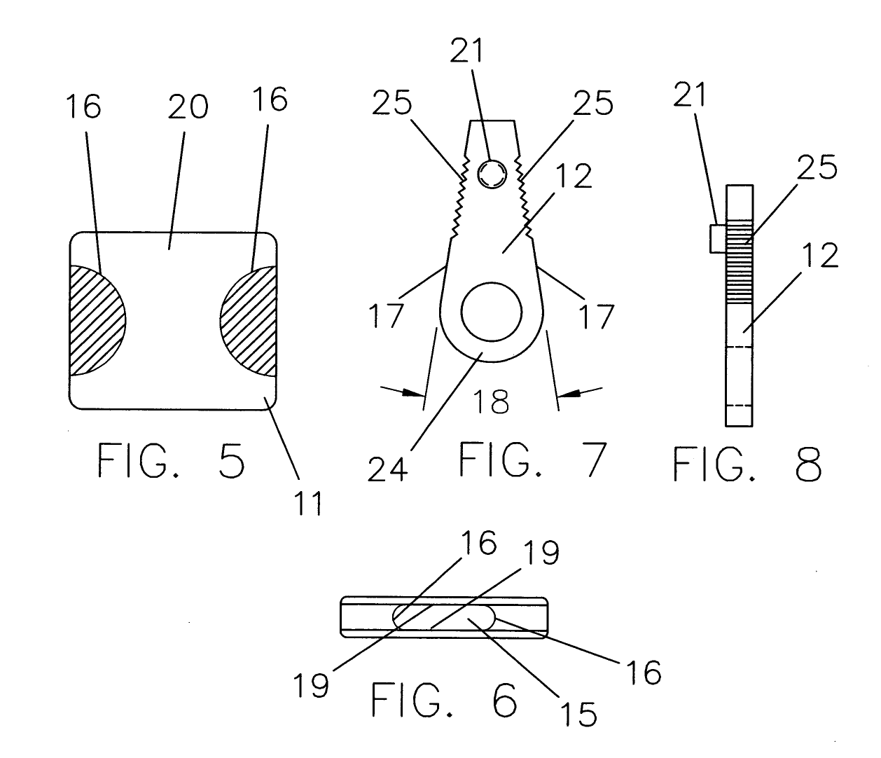

The cord lock 10 is illustrated in FIG I fully assembled showing a housing 11 holding a sliding wedge 12 and a pair of cord parts 13 in operating relation. FIG. 2 shows a view as cord lock 10 would appear as viewed in FIG. 1 from above. FIG. 3 illustrates a cross section view of device in the unlocked position revealing the inner relationship of housing 11 where wedge 12 resides between cord parts 13, which follow a pair of opposing convex walls 16, which appear more clearly in FIG. 5. FIG. 5 illustrates a cross section view of housing 11 free of cord parts 13 and wedge 12. FIG. 6 illustrates housing 11 from a view showing cavity 15 free of cord parts 13 and wedge 12 and further revealing a remaining pair of flat walls 19 that, with convex walls 16, form cavity 15. FIG. 7 shows wedge 12 fashioned with a pair of sloped sides 17 at an angle 18 developed to optimize the locking characteristics of the device. Specifically, if angle 18 is too great it will act less as a wedge and not be drawn into cavity 15 properly, allowing cord parts 13 to slip past wedge 12. If angle 18 is too small it will require too much travel to eventually lock as the wedge effect will be too gradual. There will be a range of angles where proper actuation will occur between the above mentioned extremes. There can also be a set of ridges 25, shown in FIG. 7 and FIG. 8, which can enhance the friction characteristics of wedge 12. FIG. 7 also shows a projection 21, which resides in a slot 22 which resides in one wall 19, seen in FIG. 1 and has the purpose of restraining wedge 12 from movement beyond what is required for proper actuation of the device. Slot 22 has a length where wedge 12 is allowed to move from a position where the device is locked, to a position where cord parts 13 can move, as arrows 15 in FIG. 3 indicate, yet still maintain slight contact so as not to loose communication with cord parts 13. Housing 11 has walls 19 shown in FIG. 6 that are designed to be flexible enough to allow wedge 12 to be installed and allow cavity 15 to be forced wider to allow projection 21 to pass under slotted wall 19 to engage slot 22. Projection 21 has a length which allows desirable engagement in slot 22 without requiring wall 19 to be deformed upon installation of wedge 12 to a point where wall 19 will be damaged. Wedge 12 is further fashioned with a loop 24 shown in FIG. 7, which has a size and shape where it can be comfortably pulled, disengaging wedge 12 from a locked position. Holding wedge 12 by use of loop 24 in this fashion, cord parts 13 are allowed to move through the cord lock, without the device locking, to adjust cord parts 13 as needed before tightening. Wedge 12 has a loop 24, which enables manual manipulation of wedge 12.

The cord parts 13 can be of one loop where a tension force is maintained and utilized in examples including but not limited to binding an object or bundle or to draw closed a bag or tighten a cover. The cord parts 13 can also be fastened to other objects to be drawn toward each other or held together in some fashion.

### Operation

To tighten cord parts 13, cord parts 13 are pulled tight by the operator, in an outward direction, one cord part 13 in each hand, indicated by arrows 15 in FIG. 3. This draws a tension force in cord parts 13 on the opposite side of the cord lock. This also drags, by friction, wedge 12 outward until projection 21 reaches the end of slot 22. In this position, wedge 12 still contacts cord parts 13 but not enough to prevent cord parts 13 from slipping past wedge 12, but enough that, when the movement direction of cord parts 13 reverses, wedge 12 is dragged back into cavity 15. When the operator releases cord parts 13, the residual tension force in cord parts 13 on the opposite side of the cord lock, indicated by arrows 24 in FIG. 4, pulls cord parts 13 back through the device in a direction that drags the wedge 12 back into cavity 15. Cord parts 13 are then wedged in a progressive manner against adjacent walls 16 of cavity 15, causing the build up of friction resisting the residual tension force 24 in cord parts 13. When the friction force builds to the point where it equals the residual tension force, cord parts 13 stop and are considered locked. This position is shown in FIG. 4. When cord parts 13 are once again pulled in the reverse direction, wedge 12 is dragged out of cavity 15 and the outward force it exerts against cord parts 13 holding them against the walls 16 of cavity 15 decreases releasing cord parts 13 to slide once again. Cord parts 13 can also be released by withdrawing wedge 12 from cavity 15. In this embodiment this is accomplished by pulling loop 24 shown in FIG. 7 so that cord parts 13 can be released when desired.

### CONCLUSION AND RAMIFICATIONS

The reader will see that my cord lock is an advancement in the technology and use of cords as fastening devices. With this advancement of drawstring arrangements, their use would be widened. Also the performance standard expected of these arrangements would be increased.

While my above description contains many specificities, these should not be construed as limitations on the scope of the invention, but rather as an exemplification of one preferred embodiment thereof. Many other variations are possible.

Accordingly, the scope of the invention should be determined not by the embodiment(s) illustrated, but by the appended claims and their legal equivalents.

I claim:

1. A cord lock comprising:
A housing means containing a passage with a pair of substantially convex opposing walls joined by and completing said passage a pair of substantially flat and parallel walls; said passage having a most narrow point where said convex walls are of nearest relation to each other; a wedge means member formed by a pair of substantially flat and parallel opposite sides joined by a pair of opposite sloped sides spaced closer together at a narrow end of said wedge means and farther apart at a wide end of said wedge means; said wedge means positioned at least partially within said passage with said sloped sides each adjacent to one of said convex opposing walls whereby in combination with said housing is formed a set of two passages between said sloped sides and each adjacent said convex wall on opposite sides of said wedge means where a set of two cord parts can pass through said passage; said convex walls placed at a spacing whereby said wedge with said cord parts one on each side near said narrow end of said wedge means together can pass through said narrow point; said spacing further determined whereby said wedge with said cord parts one on each side near said wide end of said wedge means together cannot pass through said narrow point.

2. Wedge member in claim 1. Further arranged to engage said cord parts at the narrowest point of said passage.
